(19) United States
(12) Patent Application Publication
(10) Pub. No.: US 2004/0068917 A1
(43) Pub. Date: Apr. 15, 2004

(54) Portable insect capturing apparatus

(76) Inventor: Chi T. Chan, Toronto (CA)

Correspondence Address: Dan de la Rosa, Suite 27H, 345 E 80th Street, New York, NY, 10021, US

(21) Appl. No.: 10/267,125

(22) Filed: Oct. 10, 2002

(51) Int. Cl. A01M 1/04; A01M 1/08

(52) U.S. Cl. 43/113

(57) ABSTRACT

A portable insect capturing apparatus is provided wherein the apparatus comprises a housing constructed of an opaque material and having an entrance and an internal cavity; an ultraviolet (UV) light source for attracting insects, the light source being situated within the internal cavity of the housing wherein the light emitted by the light source is visible to the insects from the entrance; a motor and at least one suction pump for creating a suction within the internal cavity of the housing; a power source; and a compartment for holding the captured insects.

### BACKGROUND OF THE INVENTION

1. Field of the Invention

The present invention relates to an apparatus for capturing insects, particularly mosquitoes. More specifically, the present invention provides a portable apparatus for capturing insects, the apparatus comprising a housing constructed of an opaque material and having an entrance and an internal cavity; a light source for attracting insects, the light source being situated within the internal cavity of the housing wherein the light emitted by the light source is visible to the insects from the entrance; a motor and at least one suction pump for creating a suction within the internal cavity of the housing; a power source; a compartment for holding the captured insects and a means for mounting the apparatus.

2. Description of the Related Art

There are numerous prior art patents covering insect traps, capturing devices and exterminating apparati, which utilize lights, such as ultraviolet, fluorescent, etc., to attract insect into the trapping and/or exterminating device. The most popular and effective light source is the blue ultraviolet lights, which may have detrimental effect on the human eyes with continued, long-term direct contact of the eyes with such light sources. The challenge has been finding an apparatus that utilizes the blue ultraviolet light without exposing the human eye to its deleterious effects.

The prior art also uses fans and other suction devices to capture and/or exterminate insects when the insects are in close to the “trap or kill zone” of the device. The existing fans and suction devices are noisy and inefficient in its use of its power source. This is brought about by the fact that the fans and suction devices have to circulate from outside the apparatus in order to get the insects into the “trap or kill zone”. Such devices that circulate air externally to induce or force the insects into the device will be effected during outdoor use when there is a breezy or windy day. The challenge in using such suction devices is to provide a device that provides a more efficient and effective design.

The prior art devices have also become cumbersome and limited in its mobility because of size and bulkiness. The devices have also been employing various components that may cause detrimental effects to its user, such as propane tanks, chemicals, electrical charges and electrocution voltage shocks, etc. The other problem is that some of these devices are noisy and difficult to use.

The present invention provides for a portable insect capturing apparatus that overcomes the above problems and that provides a quiet, efficient and effective method for trapping and/or killing insects, particularly flying insects such as mosquitoes. The present invention employs a blue ultraviolet light source that is not exposed to the human eyes and uses a silent suction mechanism that stays within the internal cavity of the housing of the apparatus.

### SUMMARY OF THE INVENTION

In one embodiment, the present invention relates to an insect capturing apparatus comprising: a housing having an entrance and an internal cavity, the housing being constructed of an opaque material; a light source for attracting insects into the entrance, the light source being situated within the internal cavity and the light being emitted by the light source being visible to the insects from the entrance; a motor and at least one suction pump for creating a suction within the internal cavity of the housing; and a power source and at least one compartment for holding the captured insects.

In another embodiment, the light source is a blue ultraviolet (UV) light; the light source can be fluorescent light, incandescent lights, or any other light that would attract insects, particularly flying insects such as mosquitoes. The light source of the present invention may include phosphors for enhancing the ultraviolet content of the light emitted by the bulb of the light source. It should be understood that different species of insects, including mosquitoes, have different sensitivities to lights of various wavelengths. Thus, the light source may use light of wavelengths and/or intensities for attracting different species of insects by providing incandescent sources for some species, infrared sources for other species, and other UV wavelengths for yet other species. In yet another embodiment, the power source is a battery, such as a rechargeable battery. In still another embodiment, the power source includes a plug and an extension cord.

In still yet another embodiment, the compartment is detachable from said housing, allowing the disposal of the captured insects. In a further embodiment, the apparatus further comprises means for mounting said apparatus onto a wall, a ceiling, a fence, or any viable place where the apparatus can be placed. The mounting means includes, but is not limited to hooks, hang tags, hangers, mounting rings, hoops, stands, etc.

In yet a further embodiment, the housing has a top and bottom portion, the entrance being situated on said top portion of said housing. In still a further embodiment, the housing has a top and bottom portion, the entrance being situated on said bottom portion of said housing.

In still yet a further embodiment, the housing has a funnel shaped top portion tapering into a bottom portion, the motor, suction pump, power source and compartment being situated on the bottom portion of the housing, the internal cavity and the light source being situated within the top portion of the housing. In another embodiment, the compartment further comprises a means for exterminating the captured insects. The exterminating means includes but is not limited to adhesives, chemicals, water or liquid for drowning the insects, suffocation, and any other known methods for exterminating the captured insect within the compartment. In a further embodiment, the apparatus comprises the hormones of the targeted insects, the hormones being situated adjacent to the entrance of the housing to thereby attract such insect to enter the entrance and be captured by the suction within the internal cavity of the housing. In yet another embodiment, the motor comprises a silent high-speed motor and the bottom portion comprises ventilation holes.

In still another embodiment, the present invention provides for a portable apparatus for attracting and capturing insects, the apparatus comprising: a funnel shaped top portion constructed of an opaque material, the top portion having an entrance, an internal cavity and an exit; a base situated underneath the top portion, the exit of the top portion leading to the base; a light source for attracting insects into the entrance of the top portion, the light source being situated within the internal cavity of the top portion and the light being emitted by the light source being visible to the insects from the entrance; a motor and at least one suction pump for creating a suction within the internal cavity of the housing; and a power source, at least one compartment for holding the captured insects and a means for mounting the apparatus.

In yet another embodiment, the apparatus further comprising a valve, the valve being situated between the exit of the top portion and an upper portion of the base. In still yet another embodiment, the motor, suction pump, power source and compartment being situated in the base.

In a further embodiment, the present invention provides for a portable insect trapping and capturing apparatus comprising: a housing having an entrance and an internal cavity, said housing being constructed of an opaque material, said housing having a top and bottom portion and said entrance being situated underneath said bottom portion of said housing; a light source for attracting insects into said entrance, said light source being situated within said internal cavity and the light being emitted by said light source being visible to the insects from said entrance; a motor and at least one suction pump for creating a suction within said internal cavity of said housing; a power source; at least one compartment for holding the captured insects; and a means for mounting said housing; wherein the motor, suction pump, power source, compartment and mounting means are situated on the top portion of the housing.

In another embodiment, the funnel shaped housing of the apparatus is inverted and the entrance for the insect is from underneath the apparatus. In still another embodiment, the apparatus comprises at least two housings with two separate entrances, the housings and entrances being situated on opposing sides of the base, which contains the motor, suction pump, power source and insect compartment. In yet another embodiment, the entrances are on the top and underneath bottom portions of the apparatus. In still yet another embodiment, the housing with its insect entrance may be situated on the sides of the apparatus.

### BRIEF DESCRIPTION OF THE DRAWINGS

The accompanying drawings are included to provide a further understanding of the present invention. These drawings are incorporated in and constitute a part of this specification, illustrate one or more embodiments of the present invention, and together with the description, serve to explain the principles of the present invention.

FIG. 1 is a perspective view of one embodiment of the insect capturing apparatus of the present invention;

FIG. 2 is a perspective elevated view of the components of FIG. 1;

FIG. 3 is a side view of the portable apparatus of FIG. 1;

FIG. 4 is a side view of the components of FIG. 1;

FIG. 5 is an overhead view of FIG. 1;

FIG. 6 is a cross-sectional view of one of the embodiments of the present invention;

FIG. 7 is a cross-sectional view of the apparatus showing how the insects are captured by the present invention; and

FIG. 8 is a side view of another embodiment of the present invention having at least one flat side wall being designed for wall mounting.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessary to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

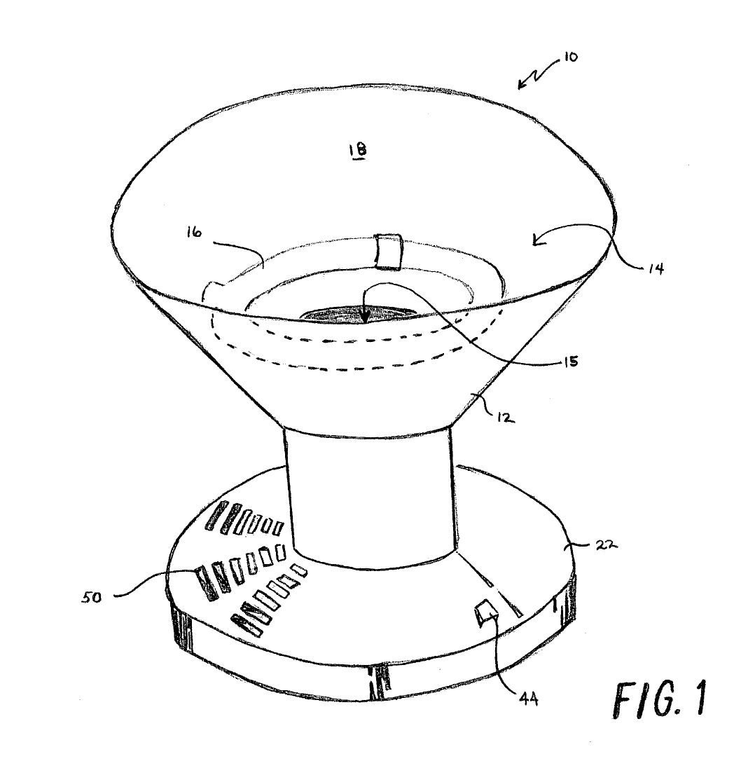

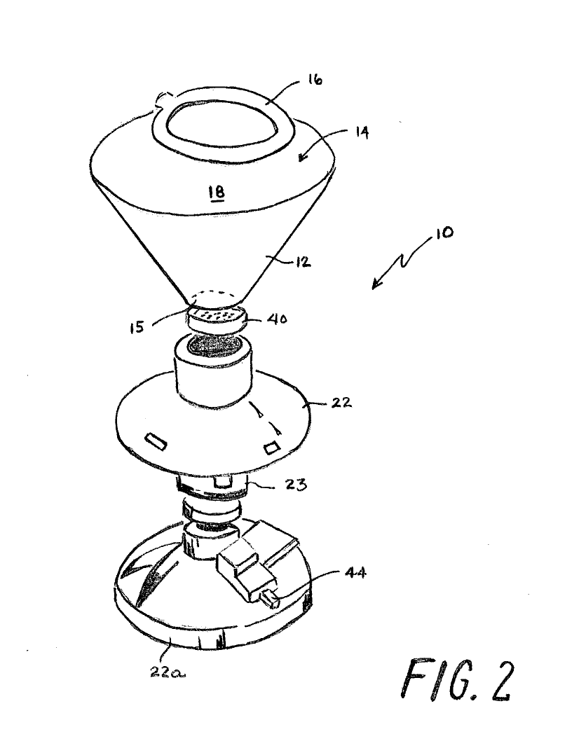

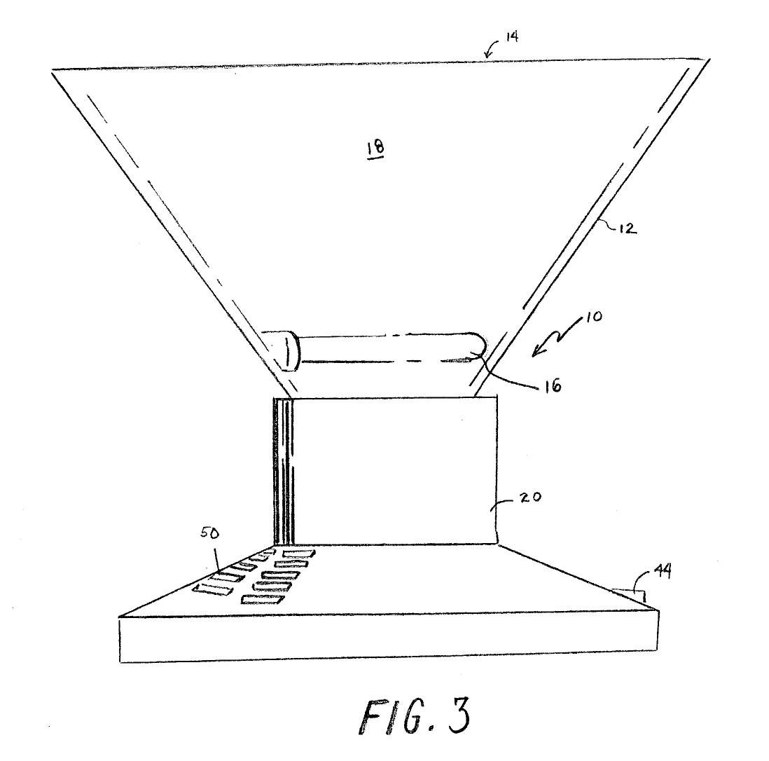

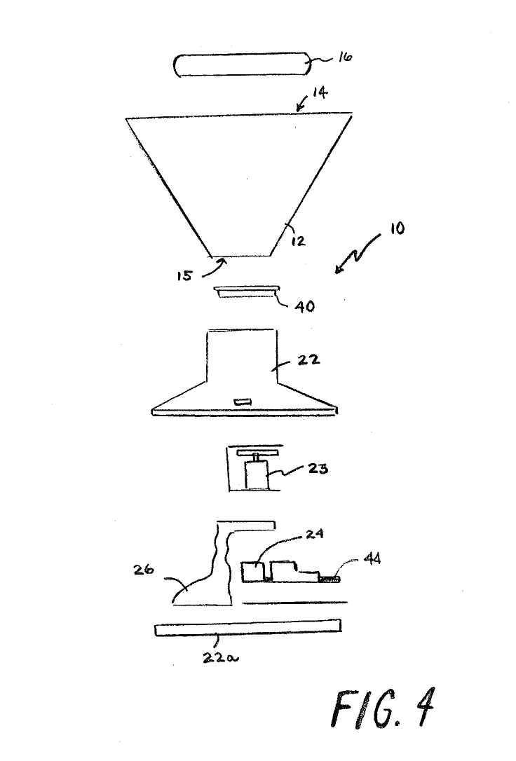

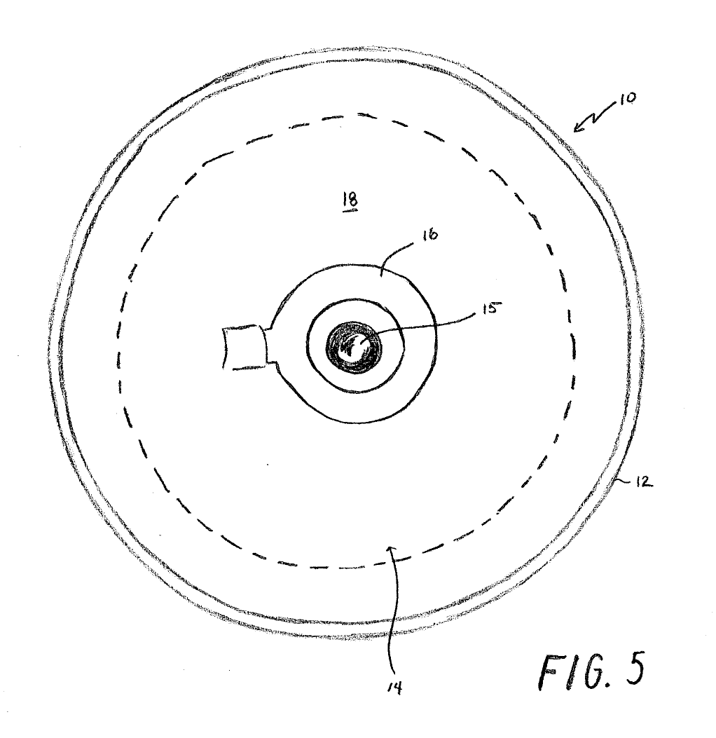

Referring now to FIGS. 1-5, the apparatus 10 of the present invention comprises: a funnel shaped top portion 12 having an entrance 14 and an exit 15 situated on opposing ends and an internal cavity 18; a light source 16 situated in the internal cavity 18 of the housing 12; a base 22a and a base housing 22 situated underneath the top portion 12; a motor 23 and a suction pump (not shown) designed to create the suction within the internal cavity 18 of the top portion 12, and being situated within the base 22; a power source, such a rechargeable battery 24 and an insect compartment 26, both being situated within the base housing 22 and the exit 15 of the top portion 12 leading to the compartment 26, where the insects are captures. In one embodiment, the compartment 26 is a washable fabric bag. In another embodiment, the compartment 26 is a disposable mesh net.

The apparatus 10 may further comprise a valve 40 situated adjacent to the exit 15 of the top portion 12 and at upper portion of the base housing 22. The valve 40 is designed to deal with the flow of the air and insects into the apparatus 12. The base housing 22 may further comprise ventilation holes 50. The apparatus 12 may also comprise an on/off switch 44, which is situated at the lower portion of the base 22.

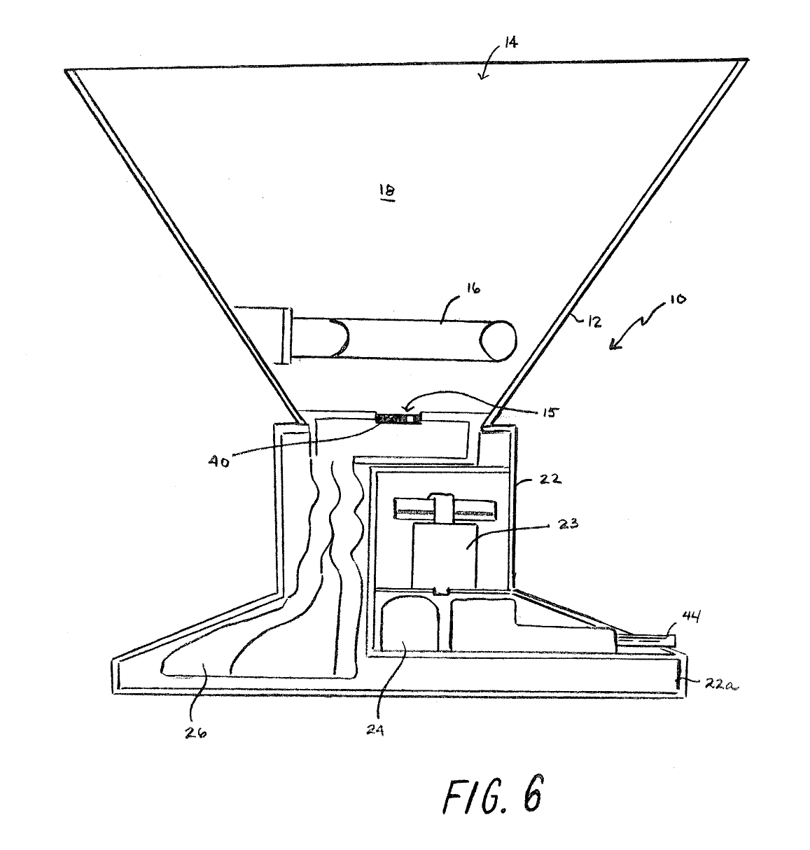

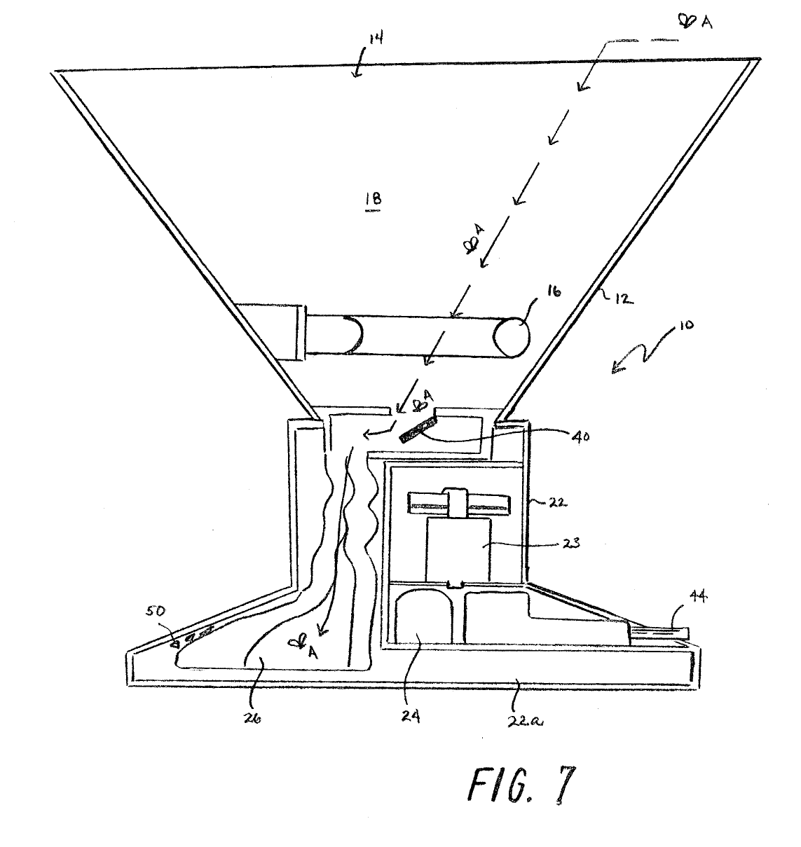

FIGS. 6-7 depict a cross-sectional view of one of the embodiments of the present invention. The light source 16, such as an ultraviolet (UV) light source, emits light that appears as a haze at the entrance 14 of the top portion 12 of the apparatus 10. The light source 16 may be situated anywhere within the internal cavity 18 of the top portion 12, but in one embodiment, the light source 16 is placed near the exit 15 of the top portion 12. Since the top portion 12 is made of an opaque material the light and the light source 16 does not make direct contact with the human eyes. However, the light (or haze of light) is visible to insect A from the entrance 14 and thereby attracts the insect A into the internal cavity 18 of the top portion 12. The insect A is then captured by the suction within the internal cavity 18, created by the motor 23 and suction pump (not shown). The insect A is driven past the exit 15 of the top portion 12 and into the insect compartment 26. The valve 40 regulates the flow of air from the internal cavity 18 into the base 22 and finally into the insect compartment 26. The valve 40 during an inactive stage closes the exit 15 and when an insect is captured by the suction, the valve 40 opens the exit 15 and the insect is directed into the compartment 26.

In another embodiment, the compartment 26 is removable form the base 22 for disposal of the captured insects. In still another embodiment, the compartment 26 is a disposable mesh bag, which can be replaced by the user when such bag is filled to capacity with captured insects. The compartment 26 may comprise a means for exterminating the captured insects, such as chemicals, water for drowning, etc.

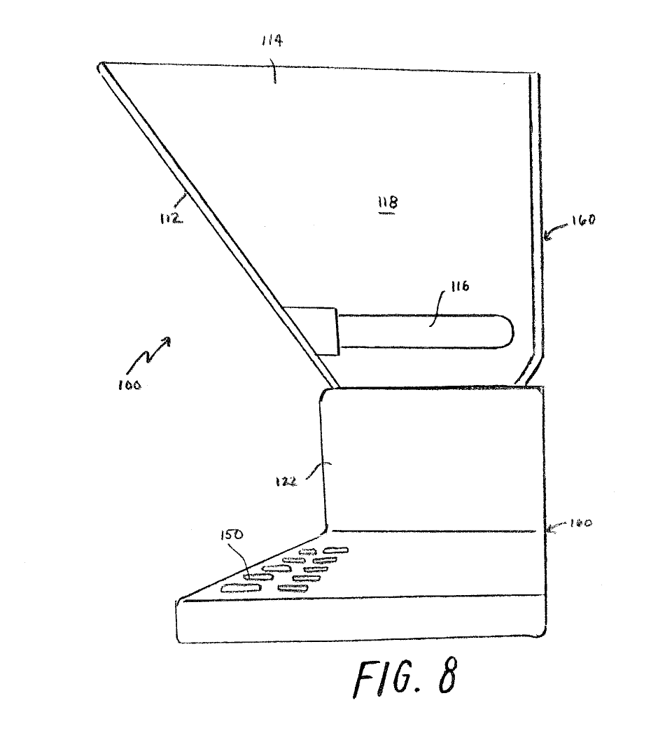

FIG. 8 depicts a wall-mounting version of the apparatus 100 of the present invention. The apparatus 100 comprises at least one flat side 160 extending from the top portion 112 to the base 122a. The flat side 160 of the apparatus 100, is designed to be mounted on any flat surface, such a flat vertical wall. The apparatus 100 is comprises a top portion 112 with an entrance 114, an internal cavity 118 and a light source 116 situated within the internal cavity 118; and a base 122 with ventilation holes 150. In another embodiment, this apparatus may be mounted on a flat wall in an inverted manner, where the entrance 114 of the top portion 112 is positioned underneath the apparatus 100 and the base 122 is now above the top portion 112.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. An insect capturing apparatus comprising:
a housing having an entrance and an internal cavity, said housing being constructed of an opaque material;
a light source for attracting insects into said entrance, said light source being situated within said internal cavity and the light being emitted by said light source being visible to the insects from said entrance;
a motor and at least one suction pump for creating a suction within said internal cavity of said housing; and
a power source and at least one compartment for holding the captured insects.

2. The apparatus of claim 1 wherein said light source is a blue ultraviolet light.

3. The apparatus of claim 1 wherein said power source is a battery.

4. The apparatus of claim 1 wherein said compartment is detachable from said housing, allowing the disposal of the captured insects.

5. The apparatus of claim 1 further comprises a means for mounting said apparatus onto a wall.

6. The apparatus of claim 1 further comprises a means for mounting said apparatus onto a ceiling.

7. The apparatus of claim 1 wherein said housing has a top and bottom portion, said entrance being situated on said top portion of said housing.

8. The apparatus of claim 1 wherein said housing has a top and bottom portion, said entrance being situated on said bottom portion of said housing.

9. The apparatus of claim 1 wherein said housing has a funnel shaped top portion tapering into a bottom portion, said motor, suction pump, power source and compartment being situated on said bottom portion of said housing, said internal cavity and said light source being situated within said top portion of said housing.

10. The apparatus of claim 1 wherein said compartment further comprises a means for exterminating the captured insects.

11. The apparatus of claim 9 wherein said motor comprises a silent high speed motor and said bottom portion comprises ventilation holes.

12. A portable apparatus for attracting and capturing insects, said apparatus comprising:
a funnel shaped top portion constructed of an opaque material, said top portion having an entrance, an internal cavity and an exit;
a base situated underneath said top portion, said exit of said top portion leading to said base;
a light source for attracting insects into said entrance of said top portion, said light source being situated within said internal cavity of said top portion and the light being emitted by said light source being visible to the insects from said entrance;
a motor and at least one suction pump for creating a suction within said internal cavity of said housing; and
a power source, at least one compartment for holding the captured insects and a means for mounting said apparatus.

13. The apparatus of claim 12 wherein said light source is an ultraviolet light.

14. The apparatus of claim 12 wherein said compartment is detachable from said housing, allowing the disposal of the captured insects.

15. The apparatus of claim 12 wherein said compartment comprises a washable fabric bag.

16. The apparatus of claim 12 wherein said compartment comprises a means for exterminating the captured insects.

17. The apparatus of claim 12 further comprising a valve, said valve being situated between said exit of said top portion and an upper portion of said base.

18. The apparatus of claim 12 wherein said motor, suction pump, power source and compartment being situated on said base.

19. A portable insect trapping and capturing apparatus comprising:
a housing having an entrance and an internal cavity, said housing being constructed of an opaque material, said housing having a top and bottom portion and said entrance being situated underneath said bottom portion of said housing;
a light source for attracting insects into said entrance, said light source being situated within said internal cavity and the light being emitted by said light source being visible to the insects from said entrance;
a motor and at least one suction pump for creating a suction within said internal cavity of said housing; and
a power source; at least one compartment for holding the captured insects; and a means for mounting said housing;
wherein said motor, suction pump, power source, compartment and mounting means are situated on said top portion of said housing.

20. The apparatus of claim 19 wherein said compartment comprises a means for exterminating the captured insects.
